(19) United States
(12) Patent Application Publication
(10) Pub. No.: US 2023/0101008 A1
(43) Pub. Date: Mar. 30, 2023

(54) VEHICLE CONTROL DEVICE AND UPDATING METHOD OF VEHICLE CONTROL DEVICE

(71) Applicant: HONDA MOTOR CO., LTD., Tokyo (JP)

(72) Inventor: Tadashi NARUSE, Tokyo (JP)

(21) Appl. No.: 17/952,963

(22) Filed: Sep. 26, 2022

(30) Foreign Application Priority Data
Sep. 30, 2021 (JP) 2021-162274

(51) Int. Cl. G06F 8/65; B60W 30/182; B60W 10/22

(52) U.S. Cl. CPC G06F 8/65; B60W 30/182; B60W 10/22; B60W 2710/226

(57) ABSTRACT

A vehicle control device provides control over a prescribed unit. The vehicle control device includes: a program configuration information storage part that is configured to store therein a program for controlling the unit having been installed; a program update determination part that is configured to, when the unit is replaced by another, reference the program configuration information storage part and thereby determine whether or not an update of the program is required; and a program update part that is configured to update the program via OTA.

### CROSS REFERENCE TO RELATED APPLICATIONS

This application claims the benefit of Japanese Patent Application No. 2021-162274 filed on Sep. 30, 2021, the disclosure of which is incorporated herein by reference.

### BACKGROUND OF THE INVENTION

### 1. Field of the Invention

The present invention relates to a vehicle control device and an updating method of the vehicle control device, in each of which software of an ECU can be updated.

### 2. Description of the Related Art

In ADS (Adaptive Damper System) of a vehicle, software of an ECU (Electronic Control Unit) performs various functions such as setting of an operating mode and controlling of an active damper.

Thus, when a unit of a vehicle is replaced or a normal part is replaced by a sport-type part such as an active damper, the vehicle needs to be taken in a dealer at which a program (as part of software) of an ECU relevant to the replaced unit is installed or updated (see Patent Document 1).

Patent Document 1: Japanese Laid-Open Patent Application, Publication No. 2008-248699

### SUMMARY OF THE INVENTION

Patent Document 1 discloses a technique in which, when a part of a vehicle is replaced in a dealer or the like, for example, history information on an ECU corresponding to the part is stored in a server, so as to bring all of the information on the ECU together and to improve traceability of the ECU information.

The technique fails to, however, take into account a case where a user himself/herself replaces a part of a vehicle. The case requires inconvenience for the user to take the vehicle in a dealer so as to update the ECU.

In light of the described above, the present invention is made in an attempt to, even when a user himself/herself replaces a part (a unit) of a vehicle, enable a software or a program of an ECU of the vehicle to be updated, without a need for taking the vehicle in a dealer.

The present invention is made also in an attempt to create a sustainable transportation system by improving convenience.

In order to solve the problems described above, a vehicle control device of the present invention, which provides control over a prescribed unit includes: a program configuration information storage part that is configured to store therein a program which functions as a control part controlling the unit having been installed; a program update determination part that is configured to, when the unit is replaced by another, reference the program configuration information storage part and thereby determine whether or not an update of the program is required; and a program update part that is configured to update the program via OTA.

The vehicle control device of the present invention makes it possible for a user to replace a unit of a vehicle by himself/herself without inconvenience of taking the vehicle in a dealer so as to install or update a program of an ECU of the vehicle.

### BRIEF DESCRIPTION OF THE DRAWINGS

FIG. 1 is a diagram illustrating a system configuration of a vehicle control device according to an embodiment of the present invention.

FIG. 2 is a diagram illustrating a structure of program configuration information according to the embodiment.

FIG. 3 is a flowchart for explaining a processing of updating a program of the vehicle control device according to the embodiment.

FIG. 4A is a diagram illustrating an example of a setting screen according to the embodiment.

FIG. 4B is a diagram illustrating a mode setting screen before updating according to the embodiment.

FIG. 4C is a diagram illustrating a mode setting screen after updating according to the embodiment.

### DETAILED DESCRIPTION OF THE EMBODIMENTS

A vehicle control device 10 of a vehicle according to an embodiment of the present invention is described with reference to related drawings.

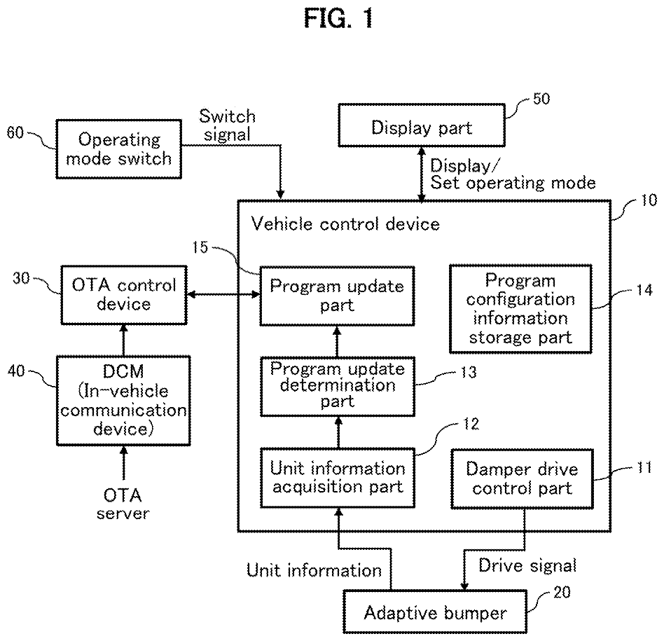

FIG. 1 is a diagram illustrating a system configuration of the vehicle control device 10 when the vehicle control device 10 provides control over a damper and an ECU relevant thereto is a suspension ECU which controls an attitude of the vehicle, according to the embodiment of the present invention.

The vehicle control device 10 of a vehicle includes a damper drive control part 11 that controls a damping force of an adaptive bumper 20 of each of, for example, four wheels, based on a stroke length of the adaptive bumper 20 and a vehicle speed and a rate of acceleration of the vehicle. The damper drive control part 11 realizes a function of controlling the damping force, using a prescribed program.

The program for realizing the damper drive control part 11, for example: calculates a value satisfying a prescribed damping force characteristic, based on a stroke length and an acceleration detected; and controls an amount of current of a coil inside the adaptive bumper 20 by outputting a drive signal, to thereby regulate a pressure at which a valve is opened and control the damping force of the adaptive bumper 20.

The damping force characteristic can be set by a user as an operating mode.

The program for realizing the function of the damper drive control part 11 is dependent on the adaptive bumper 20. In some cases, the program provides control with a different control parameter set (a variant code value) of the program in accordance with the number of corresponding operating mode (a damping force characteristic).

In order to change a program or a variant code value as described above, the vehicle control device 10 includes a unit information acquisition part 12, a program update determination part 13, a program configuration information storage part 14, and a program update part 15.

The unit information acquisition part 12 acquires unit information which is information for identifying a unit (the adaptive bumper 20) to be controlled by the vehicle control device 10 (for example, a unit number). Details of the unit information will be described hereinafter.

The program update determination part 13 determines whether or not the unit information acquired by the unit information acquisition part 12 has been stored in the program configuration information storage part 14 to be described later. When the unit information has not been stored in the program configuration information storage part 14, the program update determination part 13: determines that the unit has been replaced; updates a program of interest to another corresponding to the unit information; and updates data in the program configuration information storage part 14. When the unit information has been stored, the program update determination part 13 determines that the unit has not been replaced. In sum, the program update determination part 13 determines whether or not the unit has been replaced by another.

The program update determination part 13 performs the above-described determination in response to IG-ON (ignition power ON).

When the program update determination part 13 determines that the unit has been replaced, the program update part 15 instructs an OTA control device 30 to acquire a program corresponding to the unit information. Based on the program acquired from the OTA control device 30, the program update part 15 updates a program such that the damper drive control part 11 serves as a control part that controls a unit identified by the unit information.

The OTA control device 30 also serves as the control part that acquires a prescribed program from an OTA server which distributes a program via a DCM 40 (Data Communication Module: an in-vehicle communication device) using OTA (Over The Air) technology.

The OTA control device 30: acquires a program corresponding to the unit information; acquires a program of an ECU which has a dependency with the program corresponding to the unit information; and change the program of the ECU having the dependency. For example, when there is a change in the number of operating modes to be supported, in association with a change in a function of the vehicle control device 10 (the suspension ECU), the OTA control device 30 updates a program of the ECU, which performs displaying and/or setting of the operating mode.

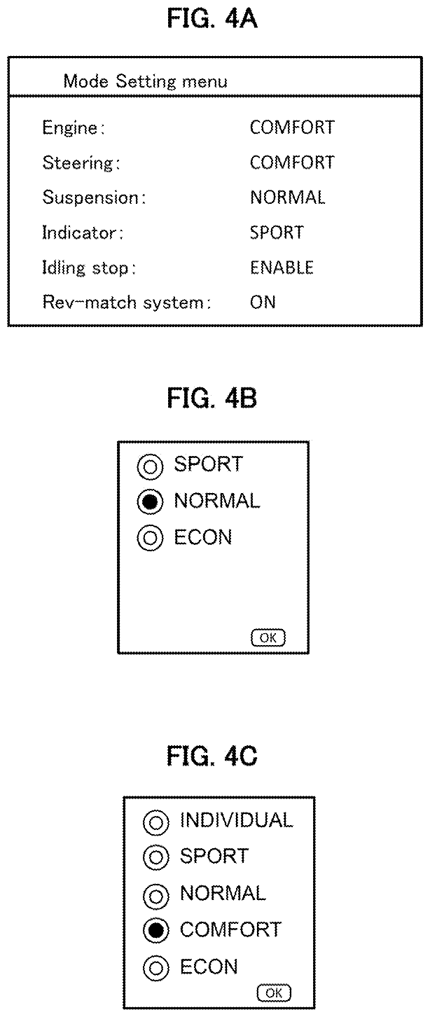

The display part 50: is an indicator display part or a navigation screen of a vehicle; and displays or sets an operating mode of the vehicle control device 10 (the suspension ECU). How the display screens appear when an operating mode is changed to the adaptive bumper 20 will be described hereinafter with reference to FIG. 4A, FIG. 4B, and FIG. 4C.

The operating mode switch 60 is a switch used when a driver instructs a vehicle to switch the operating mode of the adaptive bumper 20. The vehicle control device 10 (the suspension ECU) receives a switch signal from the operating mode switch 60; and thereby makes the damper drive control part 11 change the operating mode of the adaptive bumper 20.

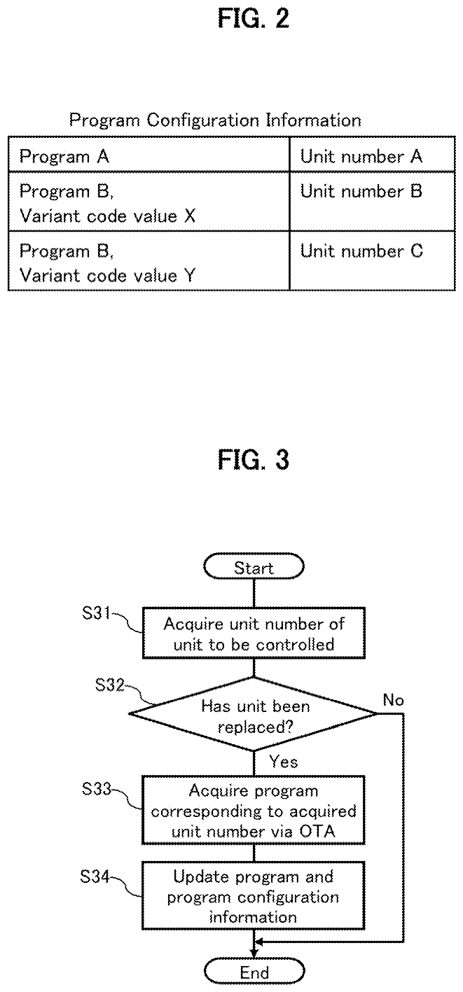

FIG. 2 is a diagram illustrating a structure of program configuration information which is stored in the program configuration information storage part 14 (see FIG. 1).

The program configuration information includes two pieces of information in pairs, namely: a program name (Program name A) of a program that functions as the damper drive control part 11 which provides control over a unit (a damper) identified by a unit number as unit information; and the unit number of the unit to be controlled (Unit number A).

When a given control parameter set (a variant code value) of a program for controlling a given unit (a damper) is changed to another control parameter set, so as to change an operating mode (a damping force characteristic), the program configuration information is made to specify a program corresponding to a unit number of the unit to be controlled, by using a program name and a variant code value.

Note that FIG. 2 illustrates an example having three pieces of program configuration information. Actually, however, the program configuration information storage part 14 stores therein a single piece of the program configuration information.

When a unit is replaced and a variant value of program configuration information of interest is thereby changed (even when a name of a program of interest remains the same), the program update part 15 updates the variant value without acquiring any program by the OTA control device 30.

Description above is made assuming that the unit information is a unit number. The unit information may be, however, a program name, or a program name and a variant code value as a pair.

Next is described a processing of updating a program of the vehicle control device 10 according to the embodiment, with reference to a flowchart of FIG. 3.

The flowchart of FIG. 3 illustrates that at a time of IG-ON (ignition power ON) of a vehicle after the adaptive bumper 20 is replaced, the vehicle control device 10 (the suspension ECU) performs a processing of updating a program such that the damper drive control part 11 functions as a control part for controlling the adaptive bumper 20.

In step S31, the unit information acquisition part 12 of the vehicle control device 10 acquires a unit number (unit information) of a unit to be controlled.

In step S32, the program update determination part 13 of the vehicle control device 10 references the program configuration information storage part 14; and compares the unit number acquired in step S31, with a unit number (unit information) in the program configuration information. If the compared unit numbers are different from each other, the program update determination part 13: determines that the unit has been replaced (Yes in S32); and advances the processing to step S33. If the compared unit numbers are the same, the program update determination part 13: determines that the unit has not been replaced (No in S32); and terminates the processing. That is, the program update determination part 13: determines whether or not the unit to be controlled has been replaced; and thereby determines whether or not updating of a program of interest is necessary. Note that, if “Yes” in step S32 (if the unit has been replaced), an update of the program is required.

In step S33, the program update part 15 of the vehicle control device 10 acquires a program corresponding to the unit number (the unit information) acquired in step S31 from the OTA server.

In step S34, the program update part 15 of the vehicle control device 10: updates the program; and changes the function of the damper drive control part 11 to serve as a control part for controlling the unit, of which unit number (the unit information) has been acquired in step S31. The program update part 15 then: updates the program configuration information; and terminates the processing.

As described above, when a user himself/herself replaces a part of a vehicle, a program of an ECU of the vehicle can be updated without inconvenience of taking the vehicle in a dealer.

When a unit is replaced by the adaptive bumper 20, a characteristic of an engine, a suspension, or the like is changed in accordance with mode setting in a management system. Next is described how display screens (the display part 50) of the management system are changed with reference to FIG. 4A, FIG. 4B, and FIG. 4C.

FIG. 4A is a diagram illustrating an example of a setting screen of the management system in which a characteristic of a vehicle is changed.

In the management system, an operating mode or whether or not an operation can be performed of an engine, a steering, a suspension, an indicator, an idling stop, and a rev-match system can be set. FIG. 4A illustrates a screen displaying a current setting state.

In response to an instruction from a user, such as a touch on the screen, a pop-up window appears for a unit to which a change of setting is made.

FIG. 4B is a diagram illustrating a setting screen of an operating mode of a suspension before a unit is replaced by the adaptive bumper 20. The setting screen displays that, before the unit is replaced by the adaptive bumper 20, the suspension has the operating modes of “SPORT”, “NORMAL”, and “ECON” and that the vehicle control device 10 (the suspension ECU) is set to the operating mode “NORMAL”, on radio button of which a check mark is placed.

When a user places a check mark on a radio button of any of the other operating modes, the operating mode of the vehicle control device 10 (the suspension ECU) can be changed.

FIG. 4C is a diagram illustrating a setting screen of the operating mode of the suspension after the unit is replaced by the adaptive bumper 20. The setting screen displays that, after the unit is replaced by the adaptive bumper 20, the suspension has the operating modes of “INDIVIDUAL”, “SPORT”, “NORMAL”, “COMFORT”, and “ECON” and that the vehicle control device 10 (the suspension ECU) is set to the operating mode “COMFORT”, on radio button of which a check mark is placed.

When a user places a check mark on a radio button of any of the other operating modes, the operating mode of the vehicle control device 10 (the suspension ECU) can be changed.

As described above, when the unit is replaced by the adaptive bumper 20, the vehicle control device 10 (the suspension ECU) according to the embodiment updates a program that functions as the damper drive control part 11, which can provide more operating modes of the suspension.

Description above is made assuming that the vehicle control device is the suspension ECU. The present invention is not, however, limited to this and can be applied to a change of a program of a monitor ECU or the like when a user himself/herself replaces a unit such as a rear view camera or additionally mounts a new unit.

The present invention is not limited to the above-described embodiment. Various design changes can be made to the present invention without departing from the gist thereof.

### DESCRIPTION OF REFERENCE NUMERALS

10 vehicle control device
11 damper drive control part
12 unit information acquisition part
13 program update determination part
14 program configuration information storage part
15 program update part
20 adaptive bumper (unit)
30 OTA control device
40 DCM (in-vehicle communication device)
50 display part
60 operating mode switch

1. A vehicle control device which provides control over a prescribed unit, comprising:
a program configuration information storage part that is configured to store therein a program which functions as a control part controlling the unit having been installed;
a program update determination part that is configured to, when the unit is replaced by another, reference the program configuration information storage part and thereby determine whether or not an update of the program is required; and
a program update part that is configured to update the program via OTA.

2. The vehicle control device according to claim 1,
further comprising a unit information acquisition part that is configured to acquire unit information which is information on the unit,
wherein the program update determination part is configured to: reference the program configuration information storage part based on the unit information acquired by the unit information acquisition part; and thereby determine whether or not an update of the program is required.

3. The vehicle control device according to claim 1,
wherein the unit is an active damper, and
wherein the program updated by the program update part provides more operating modes of a suspension.

4. The vehicle control device according to claim 2,
wherein the unit is an active damper, and
wherein the program updated by the program update part provides more operating modes of a suspension.

5. The vehicle control device according to claim 3,
further comprising a display part that is configured to display an operating mode.

6. The vehicle control device according to claim 4,
further comprising a display part that is configured to display an operating mode.

7. An updating method of a vehicle control device, the vehicle control device providing control over a prescribed unit using a program, the updating method comprising the steps of:
acquiring unit information which is information on the unit;
referencing a program configuration information storage part of the vehicle control device in which a program for controlling the unit having been installed is stored, and determining whether or not an update of the program is required based on the acquired unit information; and
acquiring a program corresponding to the unit information via OTA, and updating the program.
